(19) United States
(12) Patent Application Publication
(10) Pub. No.: US 2012/0323669 A1
(43) Pub. Date: Dec. 20, 2012

(54) INCENTIVIZING LOW-TRANSACTION-COST PAYMENTS

(75) Inventor: Sebastian Kohlmeier, Seattle, WA (US)

(73) Assignee: Microsoft Corporation, Redmond, WA (US)

(21) Appl. No.: 13/161,642

(22) Filed: Jun. 16, 2011

(51) Int. Cl. G06Q 30/00

(52) U.S. Cl. 705/14.38

(57) ABSTRACT

Payers may be incentivized to change from a first payment option to a second payment option, if the second payment option has a lower transaction cost than the first payment option. In one example, a user makes a payment through an on-line system. The user chooses a payment instrument, such as a credit card, to make the payment. A system then determines whether there the user's chosen instrument has the lowest transaction cost, or if there are ways of making the payment that have lower transaction costs. If lower-cost ways of making the payment exist, the user may be offered an incentive to change to a payment method that has a lower transaction cost.

### BACKGROUND

There is a cost associated with making and receiving a payment. When paying by credit card, the various parties involved in the transaction (e.g., merchant's bank, recipient's bank, payment network, etc.) may charge a flat fee or a percentage of the payment amount. The amount charged may be a few cents to a few dollars, depending on the nature of the party's participation and the size of the transaction. Similarly, there may be costs associated with processing a debit card payment. Even payment by cash has a cost: Since cash is a bearer instrument with intrinsic value, it has to be secured against theft, and many banks charge their business depositors a percentage of the cash that the customers deposit to cover the cost of securing and handling the cash.

While many payment instruments have associated costs, the costs may be different for different forms of payment. Different credit cards may have different cost structures. They may charge different percentages of the transaction amount. Or, they may have flat fees that apply to low-value transactions, but the amount at which such fees are triggered may differ. Cards with a given logo (e.g., Visa) may have different payment structures depending on whether the card is a credit card, a debit card, a gift card, a rebate card, etc. Moreover, even for a given payment instrument, there may be different networks through which the payment can be routed, and the cost to route a given payment may differ from network to network.

### SUMMARY

A person who has requested to perform a payment transaction with one instrument may be offered an incentive to perform the transaction with another instrument, if the transaction cost associated with the other instrument is lower. When a user makes a payment in an online transaction (e.g., a purchase transaction, a charitable donation transaction, etc.), the system with which the user is engaging in the transaction may examine the user's chosen payment method, and may suggest another payment method associated with a lower transaction cost. For example, if making the payment with the other payment method will cost $0.50 less to process then making the same payment with the user's chosen method, then the user may be offered some amount less than $0.50 (e.g., $0.25) as an incentive to switch payment methods. If the user accepts the incentive to change payment methods, then the user, and the entity that the user is paying, may both come out ahead: the user receives money or a credit, and the entity receiving the payment pays less in transaction costs.

The decision as to whether to offer a user incentive may be based on various factors. These factors may include: the length of the user's relationship with the payee; the number and/or monetary amount of transactions that the user has performed within some period of time; whether the user has a history of accepting incentives to switch followed by switching back to the original payment method; and whether the payment method that the user has chosen is registered as the user's default payment method.

A system that accepts payments may offer the user an incentive to change payment methods while leaving the final decision to the user. However, in some cases a system may switch the payment method automatically. Moreover, a system that accepts payments may further lower the transaction cost by routing the payment through a low-cost network if there is a choice of networks.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example payment interface.

FIG. 2 is a block diagram of an example scenario in which payment methods and payment networks may be chosen.

FIG. 3 is a flow diagram of an example process of completing a payment transaction.

FIG. 4 is a flow diagram of an example process of determining whether to change a payment method.

FIG. 5 is a block diagram of example components that may be used in connection with implementations of the subject matter described herein.

### DETAILED DESCRIPTION

Many transactions (e.g., purchases, charitable donations, subscriptions, etc.) take place online and/or on a mobile device. These transactions typically conclude with a payment process, where the user is asked to make payment by one of several possible methods. Examples of payment methods include credit card, debit card, gift card, existing merchant credit (e.g., from a previous return of merchandise), micropayment account (e.g., PayPal), or any other type of method. These different types of payment methods may be associated with different cost structures, so the cost of a particular transaction may differ from method to method. Even within a given genre of payment method (e.g., credit card), there may be different costs associated with different cards. For example, Visa and American Express may have different cost structures. Additionally, even for a given brand of card (e.g., Visa), there might be different costs to process payment from two different Visa cards. (E.g., Amazon.com might pay less to receive a payment through the Amazon.com Visa card than it would have to pay to receive the same payment through a different Visa card).

Customers may have various reasons to choose a particular payment method. The customer may be enrolled in a rewards program with a particular credit card, or may have a gift card that the customer wants to use up, or may want to pay with a debit card to avoid credit card interest. However, in some cases the customer has no particular reason to choose one payment method over another, or favors the chosen payment method by only a small margin. In such a case, the customer might be susceptible to an incentive to change to a different payment method. Since transaction fees are generally paid by the entity that the customer is paying in the transaction, it is in the payee's interest to encourage the customer to change to a payment method that has a lower transaction cost, if such a payment method exists. Since a switch to a lower-cost payment method would save the payee money, it may be in the payee's interest to offer the customer some of the money saved as an incentive to switch.

The subject matter described herein may be used to encourage a payer to switch to a payment method different from the one that the payer has chosen, if a lower-cost payment method exists. In an online transaction, the payer may be shown a payment screen that gives the customer various payment options. For example, the payer may have previously registered several payment instruments (such as credit, debit, and gift cards) with the payee in the form of an online “wallet”, and may choose one of these payment instruments from among the instruments in the wallet (or the payee may have previously chosen one of the payment instruments in the wallet as the default instrument). When the payment instrument has been chosen, the payee may determine the cost associated with receiving a payment through that instrument. The payee may also calculate the cost associated with receiving a payment through other instruments in the payer's wallet, or even the cost associated with receiving payment through instruments that the payer does not currently have. If there is a lower-cost payment instrument, the payee may encourage the payer to switch to that lower-cost payment instrument by offering the payer an incentive. For example, if payment instrument A has a $0.50 lower transaction cost than payment instrument B, the payee might encourage the payer to switch from B to A by offering the payer $0.25 as an incentive. If the switch is made, the payer is enriched by $0.25 in the form of the incentive, and the payee is also enriched by $0.25. ($0.50 saved in transaction costs, minus $0.25 paid as an incentive to the payer, leaves the payee with $0.25 more than the payee would have received if the payee had to pay the higher transaction cost associated with payment instrument A). The payer's accepting the incentive allows both the payer and the payee to come out ahead, as long as the amount of the incentive is more than zero and less than the difference between the less-expensive and more-expensive payment methods.

In addition to encouraging the payer to change payment instruments, the payee may also save on transaction costs by routing the payment through a lower-cost network, when a choice of network exists. For example, there may be two different payment networks that can process a particular Visa payment, one of which has a lower cost for a particular transaction. The payee can lower the transaction cost associated with receiving a payment by routing the payment through a lower-cost network.

When deciding whether to offer the payer an incentive to change payment methods, the payee may take various factors into account. Some of these factors include: the length of the payer's relationship with the payee; the number and/or monetary amount of transactions that the payer has performed within some period of time; whether the payer has a history of accepting incentives to switch followed by switching back to the original payment method; and whether the payment method that the payer has chosen is registered as the payer's default payment method.

While the subject matter herein may be used to offer incentives to change payment methods, in some cases the payee may change the payment method automatically.

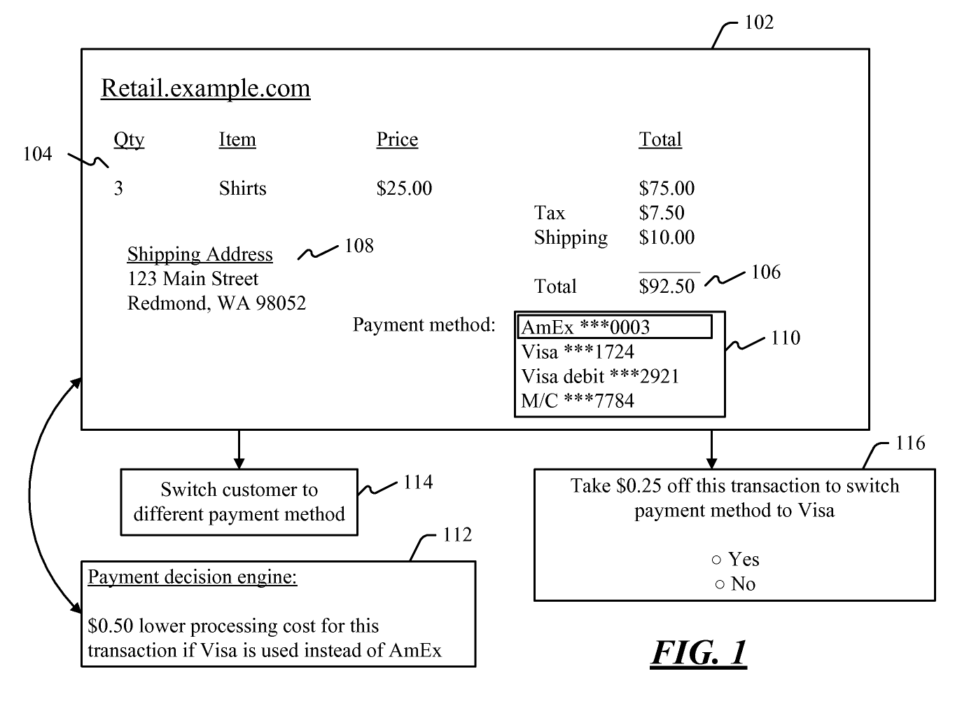

Turning now to the drawings, FIG. 1 shows an example payment interface that may be presented to a payer as part of a payment transaction. In the example of FIG. 1, the payment interface is being used to complete a purchase transaction (from the web site Retail.example.com), although a payment interface could be used to complete any sort of transaction online and/or on a mobile device—e.g., charitable donation, tax payment, subscription renewal, etc.

Payment screen 102 is part of the payment interface, and it shows the payer various pieces of information. Payment screen 102 shows what the user has purchased (numeral 104, which in this example, shows the purchase of three shirts for $25.00 each), the total amount to be paid (numeral 106, which includes charges for tax and shipping), and a shipping address 108. Payment screen 102 also shows various options of payment methods that the payer can use to complete the transaction. In the example of FIG. 1, the payer may have a pre-existing relationship with Retail.example.com, and thus may have registered various payment instruments in an online wallet 110. For the purposes of the discussion herein, an online or mobile wallet is a list of payment instruments that the payer has registered for use with a particular payee, where the payee may maintain this list for the payer's convenience. Examples of these instruments are shown, and they include an American Express card, a Visa credit card, a Visa debit card, and Master Card. (The asterisks and numbers following each card name represent the account number of that card). In the example shown in FIG. 1, the box surrounding the American Express card indicates that the payer has chosen that card as the payment instrument for this transaction, or that the American Express card is the instrument that the payer has chosen to be his or her default instrument.

Payment decision engine 112 may be a software component that operates on the payee's server, or may be a service that the payee can access which is implemented elsewhere. Payment decision engine 112 determines the transaction cost associated with the payer's chosen payment method, and may also determine the transaction cost of other payment methods. Payment decision engine 112 is then able to use this information concerning relative transaction costs to determine whether it makes sense to offer an incentive for the payer to change payment methods (or, in some cases, even to change the payment method automatically). In this example, payment decision engine 112 has determined that there will be a $0.50 lower processing cost for the transaction if the payer pays for his or her purchase with Visa instead of American Express. Payment decision engine provides this information to the payee. The payee may then decide what to do with that information.

In one example, the payee may automatically switch the payer to the lower-cost payment method (block 114), and may automatically give the customer a monetary bonus (or other type of incentive) due to the switch. (Automatic switching may occur, for example, in situations where the customer has pre-authorized the payee to choose the payment method for the customer).

In another example, the payee may display an incentive to the payee (block 116). Thus, a message such as “Take $0.25 off this transaction to switch your payment method to Visa” might be displayed to the payer, with radio buttons to accept or decline the change. If the user accepts the change of payment method, the user may receive the incentive in the form of a credit against the current transaction (by deducting the incentive from the pre-incentive dollar amount of the transaction), a credit (or “points”) that are redeemable in a future transactions, a coupon, a future discount, or in any other form.

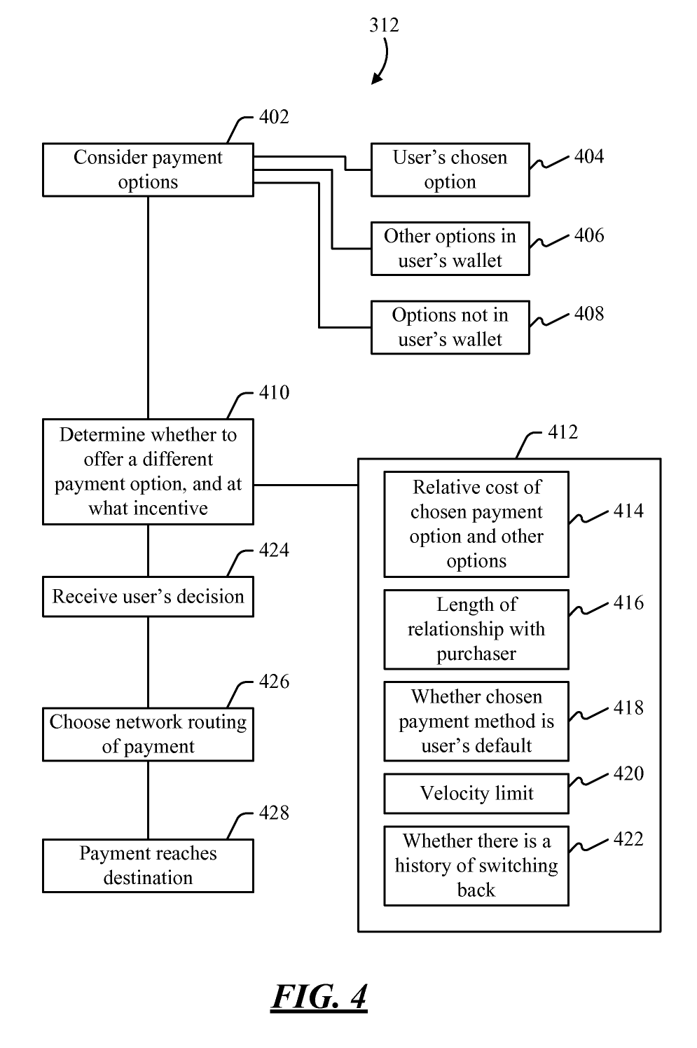

In the example discussed above, the decision to offer the user an incentive to switch is based on there being a lower-cost payment option other than the one that the user has chosen. However, there are additional factors that may go in to the decision to offer an incentive. Some of those factors are discussed below in connection with FIG. 4.

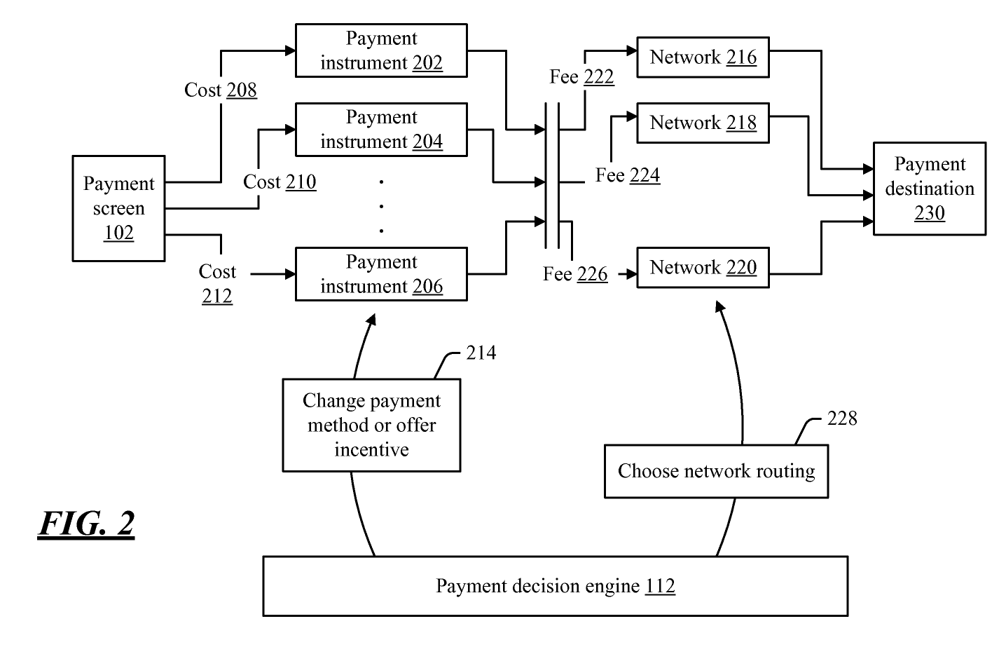

Turning now to FIG. 2, there is shown an example scenario in which payment methods and payment networks may be chosen. Payment screen 102 is shown to a payer. As discussed above in connection with FIG. 1, one aspect of payment screen 102 is that it may display the names of several payment instruments that the payer may use to complete a payment. In FIG. 2, three example payment instruments 202, 204, and 206 are shown, although there could be any number of payment instruments available to the payer. (E.g., the set of payment instruments may include all of the instruments registered in the user's wallet, of which there could be any number). The act of making a given payment with any of the payment instruments may be associated with a cost. Payment instruments 202, 204, and 206 are associated with costs 208, 210, and 212, respectively. The actual amount of the cost may be calculated according to a formula. For example, a particular credit card might charge 2% of each transaction with a minimum fee of $0.50. Moreover, for a given payment instrument, different payees might pay different fees to receive payments through that instrument. Regardless of the way in which the fee is calculated, for a given transaction and a given payment instrument, it is possible to determine the transaction cost associated with processing that transaction.

Payment decision engine 112 may consider the various costs associated with using instruments 202, 204, and 206 to process a transaction. Based on payment decision engine 112's assessment of the various costs (and also based on other factors discussed below in connection with FIG. 4), payment decision engine 112 may determine to change from one payment method to another, or to offer the payer an incentive to make the change from one payment method to another (block 214).

As described above, it may be possible to use different payment networks with the same payment instrument. For example, Visa may have a network that can be used to process Visa payments, but there may also be other networks that can process a Visa payment. There may be different costs associated with using these different networks. Once a payment instrument has been chosen, a choice may be made regarding which network will be used to transmit the payment. In the example of FIG. 2, assuming that a payment instrument has been chosen, there may three networks 216, 218, and 220 through which the payment is processable. There may be different fees for the use of each of the networks. In the example of FIG. 2, networks 216, 218, and 220 are associated with fees 222, 224, and 226, respectively. Payment decision engine 112 may choose the network routing (block 228), that is used to send the payment to its destination 230. Payment decision engine 112 may choose the routing that can be performed for the lowest fee.

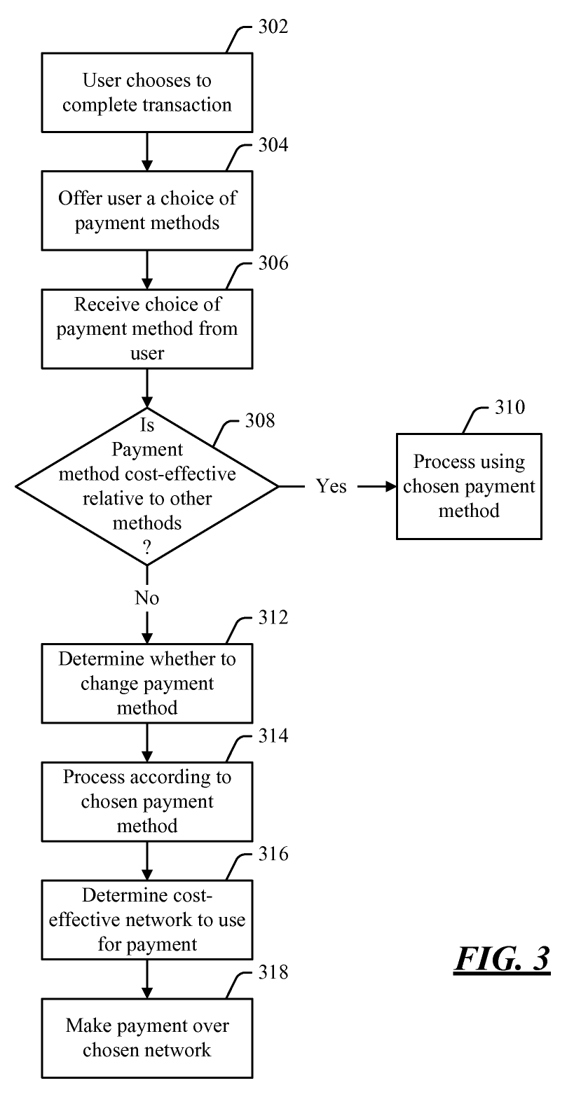

FIG. 3 shows an example process of completing a payment transaction. Before turning to a description of FIG. 3, it is noted that the flow diagrams contained herein (both in FIG. 3 and in FIG. 4) are described, by way of example, with reference to components shown in FIGS. 1 and 2, although these processes may be carried out in any system and are not limited to the scenarios shown in FIGS. 1 and 2. Additionally, each of the flow diagrams in FIGS. 3 and 4 shows an example in which stages of a process are carried out in a particular order, as indicated by the lines connecting the blocks, but the various stages shown in these diagrams can be performed in any order, or in any combination or sub-combination.

At 302, a user gives an indication that he or she is requesting to complete a payment transaction with a payee (e.g., by clicking “checkout” at the appropriate point in a web and/or mobile purchase process). At 304, the system operated by the payee may offer the user a choice of payment methods. As discussed above, the payment methods offered to the user may be the various registered payment instruments in the user's wallet. At 306, the choice of payment method is received from the user. As noted above, in some cases the user may explicitly choose a particular payment method, but in some cases the user may have pre-selected a default payment method, in which case the user's act of choosing the payment is simply the act of accepting the default.

At 308, it is determined whether the user's chosen payment method is cost-effective relative to other possible methods that could have been chosen. For example, if the user's chosen method has a higher associated transaction cost than some other payment method, then the method might not be considered to be cost-effective. If the chosen payment method is determined to be cost-effective, then the payment is processed using the chosen payment method at 310. Otherwise, the process continues to 312.

At 312, it is determined whether to change the payment method. An example of how to make this determination is discussed below in connection with FIG. 4. Moreover, the payment method can be changed either automatically, or by offering the user an incentive to change the payment method and awaiting the user's assent to accept the incentive in exchange for making the change. However, for the purpose of FIG. 3, it is merely assumed that a determination is made as to whether to make a change to the payment method; FIG. 3 is not limited to any particular way of making the change, or any particular way of determining whether to make the change.

At 314, the payment is processed in accordance with the chosen payment method. It is noted that the “chosen” payment method could be the original payment method—e.g., in the case where the system decides to use the user's original choice of payment method without any change, or in the case where the user is offered an incentive to change the payment method but declines the offer. Of course, if a change to the payment method is made, then the “chosen” payment method at 314 is the resulting payment method after the change is made. If the user has accepted the incentive and changed payment methods, then the user may receive the promised incentive—e.g., in the form of a monetary credit against the current transaction, or in the form of a credit (or “points”) that may be used in future transaction, a coupon, a future discount, or even in the form of a monetary transfer to the user.

At 316, a cost-effective network is chosen to route the payment. At 318, the payment is routed on the chosen network.

FIG. 4 shows detail of an example process of determining whether to change a payment method—i.e., an example of how to make the determination at 312 of FIG. 3.

At 402, the various payment options are considered. The various payment options may include the payment option that the user has chosen (block 404), other options in the user's wallet (block 406), or even other options that are not in the user's wallet (block 408). (Examples of options that are not in the user's wallet might include a credit card that the user does not currently have but that is being promoted to the user. Thus, a system might want to incentivize a user to apply for a credit card and to use that card for payment).

At 410, it is determined whether to offer a different payment option than the user has chosen, and what sort of incentive is to be offered to make the change to a different payment option. Various factors may be considered in order to make this determination. Examples of such factors 412 are shown.

One example factor to be considered is the relative cost of the user's chosen payment option and the other options (block 414). For example, if the user's chosen payment option has a transaction cost of $0.50 and another option has a cost of $0.25, then a decision may be made to offer the user an incentive to change the payment option. On the other hand, if the user's chosen option has a transaction cost of $0.50 and the next lowest-cost option has a transaction cost of $1.00, then a decision may be made not to offer an incentive to change the payment option.

Another example factor to be considered is the length of the relationship between the payer and the payee (block 416). For example, if the payer is a “veteran” user, then a decision might be made to incentivize the payer to change payment options, even if such an incentive might not be offered to a “novice” user. Conversely, there might be some offers that would be made to novices, but not to veterans.

Another example factor to be considered is whether the chosen payment option is the user's default payment option (block 418). For example, the user might have a wallet of payment options, one of which has been pre-selected as the user's default option. There may be reasons why a system might want to respect the user's default choice even if that choice is not the lowest cost. Alternatively, the system might specifically want to encourage the user to change from his default choice.

Another example factor to be considered is a “velocity” limit (block 420). Velocity, in this example, refers to the rate at which the user engages in transactions, based on either the number of transactions the user has engaged in during some defined period of time, or the total monetary value of transactions that the user has engaged in during that period of time. For example, a user might be considered to be a “high velocity” user if he or she has made more than ten purchases in a day, or more than $5000 worth of purchases in a day. A system might choose to avoid giving incentives to high velocity users, because high velocity purchasing might suggest that the user is trying to engage in transactions in order to get the system to offer him or her more incentives.

Another example factor to be considered is whether the user has a history of “switching back” (block 422). In some cases, a user might have accepted an incentive to change payment methods at some point prior to the current transaction, but might then change back to the originally-chosen method or to a different method after having accepted the incentive. Such users might be considered to be “fishing” for incentives, so offering further incentives to such users might be avoided.

The various factors in blocks 414-422 are merely examples. In determining whether to offer an incentive to change a payment option, any of these factors (or any other factors) may be considered in any combination or sub-combination. For example, there might be a cheaper payment option than the one that the user has chosen, which weighs in favor of offering the user an incentive to change. But the user might also be deemed to be a high-velocity user, which weighs against offering an incentive to change. Thus, a system could consider both of these countervailing factors when determining whether to offer the user an incentive to make a change.

If an incentive to change is offered, then at 424 the user's decision is received as to whether to accept the incentive and make the change. At this point, the payment option that will be used to make the payment will be either the option that the user originally chose, or the option that the user has been incentivized to change to. Whichever option is being used to make the payment, a network over which to route the payment may be chosen (at 426). The payment is then routed over that network and reaches its destination at 428.

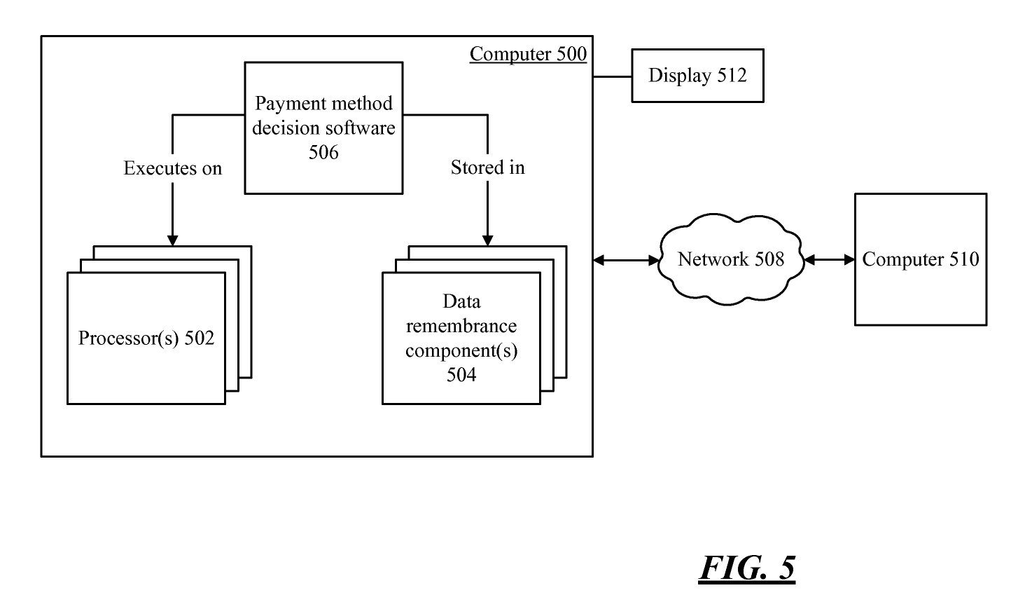

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, a mobile device (such as a wireless telephone), or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is payment method decision software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable storage media. Tangible media, such as optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium. It is noted that there is a distinction between media on which signals are “stored” (which may be referred to as “storage media”), and—in contradistinction—media that transmit propagating signals. DVDs, flash memory, magnetic disks, etc., are examples of storage media. On the other hand, wires or fibers on which signals exist ephemerally are examples of transitory signal media. The subject matter can be implemented as instructions that are stored on one or more computer-readable storage memories, where memories are devices that durably store information (and it will be understood that devices that only hold data ephemerally as propagating signals are not “memories”).

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

In the claims here, various items may be described as being “distinct” from each other. To say that two items are distinct from each other is to say that they are not the same item. For example, if a first payment method is distinct from a second payment method, then the first payment method and the second payment method are not the same method. (A Visa credit card and a Visa debit card are not the same payment method, and thus are distinct from each other. Likewise, two Visa credit cards having different account numbers are not the same as each other, and thus are two distinct payment methods).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage memories that store executable instructions to process a payment, the executable instructions, when executed by a computer, causing the computer to perform acts comprising:
receiving an indication that a user chooses to complete a payment transaction for a first amount of money;
offering said user a choice of payment methods;
receiving said user's choice of a first payment method;
offering said user an incentive to change from said first payment method to a second payment method that is distinct from said first payment method;
receiving said user's assent to change from said first payment method to said second payment method;
providing said incentive to said user; and
processing said payment transaction using said second payment method.

2. The one or more computer-readable storage memories of claim 1, said acts further comprising:
determining to offer said incentive to said user based on said second payment method having a lower cost to process said payment transaction than said first payment method.

3. The one or more computer-readable storage memories of claim 2, said incentive having a value that is more than zero and less than a difference between a cost to process said transaction with said second payment method and a cost to process said transaction with said first payment method.

4. The one or more computer-readable storage memories of claim 1, said acts further comprising:
determining to offer said incentive to said user based on a length of a relationship between said user and an entity with which said user requests to perform said payment transaction.

5. The one or more computer-readable storage memories of claim 1, said user having a wallet that comprises a plurality of payment methods, one of said payment methods being said user's chosen default payment method, said acts further comprising:
determining to offer said incentive to said user based on whether said first payment method is said user's default payment method.

6. The one or more computer-readable storage memories of claim 1, said acts further comprising:
determining to offer said incentive to said user based on a number of transactions, or a monetary amount of transactions, that said user has completed in a defined period of time with an entity with which said user requests to perform said payment transaction.

7. The one or more computer-readable storage memories of claim 1, said user having been offered, in connection with a prior payment transaction that took place before said receiving of said indication, an incentive to switch from a third payment method to a fourth payment method, said acts further comprising:
determining to offer said incentive to said user based on whether said user switched back to said third payment method after said prior payment transaction was completed.

8. The one or more computer-readable storage memories of claim 1, said second payment method being processable through a first payment route and through a second payment route, said acts further comprising:
processing said payment transaction through said first payment route based on said first payment route's having a lower associated routing cost than said second payment route.

9. The one or more computer-readable storage memories of claim 1, said incentive comprising a credit for a second amount of money, said acts further comprising:
deducting said second amount of money from said first amount of money in said payment transaction.

10. The one or more computer-readable storage memories of claim 1, said incentive comprising a credit redeemable for a future transaction but not for said payment transaction.

11. A method of processing a payment, the method comprising:
using a processor to perform acts comprising:
presenting a user with a payment interface that offers said user a plurality of payment options for payment to complete a payment transaction, said plurality of payment options being options that said user has registered in a payment wallet maintained by an entity with which said user engages in said payment transaction;
receiving said user's choice of a first payment option from said plurality of payment options;
offering said user a second payment option from among said plurality of payment options, and an incentive to change from said first payment option to said second payment option, said second payment option being distinct from said first payment option;
receiving said user's assent to change from said first payment option to said second payment option;
providing said incentive to said user; and
processing said payment transaction using said second payment option.

12. The method of claim 11, said acts further comprising:
determining to offer said incentive to said user based on said second payment option having a lower cost to process said payment transaction than said first payment option.

13. The method of claim 11, said acts further comprising:
determining to offer said incentive to said user based on a length of a relationship between said user and said entity.

14. The method of claim 11, said acts further comprising:
determining to offer said incentive to said user based on a number of transactions, or a monetary amount of transactions, that said user has completed in a defined period of time with said entity.

15. The method of claim 11, said user having been offered, in connection with a prior payment transaction that took place before the payment transaction that is being processed by said method, an incentive to switch from a third payment option to a fourth payment option, said acts further comprising:
determining to offer said incentive to said user based on whether said user switched back to said third payment option after said prior payment transaction was completed.

16. A system for processing a payment transaction, the system comprising:
a memory;
a processor; and
a payment routing decision engine that is stored in said memory, that executes on said processor, that makes a determination of whether to offer a user who engages in a payment transaction an incentive to change from a first payment method that said user has chosen to a second payment method that is distinct from said first payment method, or whether to change said user's payment method from said first payment method to said second payment method automatically, or whether to use said first payment method without changing to said second payment method, said system processing said payment transaction in accordance with said determination, said system providing said incentive to said user if said determination causes a change of payment method.

17. The system of claim 16, said user having a wallet that comprises a plurality of payment methods that are registered with an entity with which said user engages in said payment transaction, one of said payment methods being said user's chosen default payment method, said payment routing decision engine determining to offer said incentive to said user based on whether said first payment method is said user's default payment method.

18. The system of claim 16, said second payment method being processable through a first payment route and through a second payment route, said payment routing decision engine processing said payment transaction through said first payment route based on said first payment route's having a lower associated routing cost than said second payment route.

19. The system of claim 16, said payment transaction being for a first amount of money, said incentive comprising a credit for a second amount of money, said system deducting said second amount of money from said first amount of money in said payment transaction.

20. The system of claim 16, said incentive comprising a credit redeemable for a future transaction but not for said payment transaction.
